(19) United States
(12) Patent Application Publication
(10) Pub. No.: US 2023/0004913 A1
(43) Pub. Date: Jan. 5, 2023

(54) ENVIRONMENT ASSESSMENT CAPTURE VIA DATA CONFIDENCE FABRICS

(71) Applicant: EMC IP Holding Company LLC, Hopkinton, MA (US)

(72) Inventors: Nicole Reineke, Northborough, MA (US); Stephen J. Todd, North Andover, MA (US)

(21) Appl. No.: 17/305,097

(22) Filed: Jun. 30, 2021

(51) Int. Cl. G06Q 10/06; G06F 16/28

(52) U.S. Cl. CPC G06Q 10/06393; G06Q 10/0637; G06Q 10/0633; G06F 16/288

(57) ABSTRACT

One example method includes assessing an environment using a data confidence fabric. Data from sources associated with an environment such as a remote working environment is ingested into the data confidence fabric and associated with confidence scores. The environments can be assessed or monitored to ensure that the conditions of the environment comply with a standard.

### FIELD OF THE INVENTION

Embodiments of the present invention generally relate to environment assessment and related operations. More particularly, at least some embodiments of the invention relate to systems, hardware, software, computer-readable media, and methods for assessing an environment using data confidence fabrics.

### BACKGROUND

In the past, most workers or employees spent part of their day travelling to and from their place of employment. However, the working paradigm is shifting. Today, many workers can perform their job remotely and many employees are now working in a location that is remote from their employer's place of business. This shift will likely have many consequences, one of which is that employers may have some accountability for the remote work environments.

For example, there was a time when factory conditions were ignored. Employers were not liable or responsible for working conditions of their places or business or the factories they may have used. Today, however, owners often bear some responsibility for the working conditions of their employees or the working conditions of their vendor's employees.

With a continued shift to remote working, it is possible that owners or employers may become somewhat responsible for remote working conditions. For example, some workers may not be given any option other than to work from home. In this and other scenarios, it is likely that the employer may bear at least some responsibility for the working conditions of these employees. As a result, there is a need to understand the conditions of those working environments.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a data confidence fabric that ingests data from multiple sources associated with multiple environments;

FIG. 2 discloses aspects of assessing an environment using a data confidence fabric, including performing operation such as monitoring conditions of an environment, verifying employee compliance with best practices, correlating data with environment assets, and the like;

FIG. 3 discloses aspects of metadata associated with data ingested into a data confidence fabric;

FIG. 4 discloses aspects of assessing environments including remote working environments; and

FIG. 5 discloses aspects of a computing environment or a computing device.

### DETAILED DESCRIPTION OF SOME EXAMPLE EMBODIMENTS

Embodiments of the present invention generally relate to environment assessment using data confidence fabrics. More particularly, at least some embodiments of the invention relate to systems, hardware, software, computer-readable media, and methods for assessing remote environments, which includes, by way of example only, performing monitoring operations, assessment operations, data confidence fabric operations, environment grading operations, environment marketplace operations, and combinations thereof.

Generally, a data confidence fabric (DCF) is a computing system or environment that allows the trustworthiness of data to be determined. A DCF provides a flexible and automated understanding of data originators or sources of data. A DCF can account for variations in the data being ingested into the DCF. A DCF may be associated with a ledger that allows interactions with data to be recorded immutably. Ledgers facilitate tracking data lineage, performing audits, and the like. Further the ledger (or other recording) can store information about the data itself and the various trust insertion technologies that may have interacted with or on the data. A DCF can provide information to track how data moves within the DCF, who or what touches the data, when the data is touched, and the like. All of these factors allow a score (a confidence score or a trustworthiness score) to be associated with the data. The confidence score allows an application or entity to trust or value the data according to the score. For example, data with a high trust or confidence score may be relied on more than data with a relatively lower trust or confidence score.

Data ingested into the DCF can be associated with various attributes such as BIOS information, secure boot information, authentication and authorization information, immutable storage, IP address, and the like. This information may contribute to the overall score. Data that is generated on a non-secure device may receive a lower score than data generated on a device that booted securely. The confidence score can be increased when the attributes include information about provenance and/or the manner in which authentication or authorization was performed.

Embodiments of the invention may also allow users to review how the scores were generated. Some part of the confidence score, for example, may be generated in fact while other parts may be based on an inference. When the data is ready for consumption, the data will have a score that allows a decision maker to understand its trustworthiness with regard to the activity for which the data is being used. For example, decision maker or application consuming data in the context of a remote working environment may require data with confidence scores that are higher than data used to turn a light on or off.

In general, a DCF annotates and scores data that is ingested into and that flows within the DCF. Embodiments of the invention relate to DCFs in the context of remote environments. A DCF can capture or collect data related to the conditions or characteristics of a remote environment. The captured or collected data can be annotated and used in assessing remote environment environments or conditions and in performing other operations.

The ability to assess remote working conditions or remote environment conditions allows decisions to be made that benefit the worker and that validate that a company is encouraging and/or providing quality working environments. By storing annotations or metadata in a ledger, the efforts to improve working conditions can be recorded.

It is generally understood that working conditions have an impact on work quality and work quantity. Embodiments of the invention offer organizations the ability to collect environment data, correlate the environment data with the source, correlate the source with an asset, and ultimately associate remote worker or device conditions with the collected data.

Embodiments of the invention can ensure that remote working environments meet minimum standards (e.g., health standards or other regulations or other best practices). This can transparently allow an organization to demonstrate that they are actively engaged in improving working conditions, regardless of location. Further, this allows an organization to attract/retain talent, improve diversity, and the like.

Embodiments of the invention allow an entity skilled in environmental conditions, working conditions, and the like to improve their ability to evaluate remote working environments using scored data. Further, the DCF allows third parties to leverage data related to remote environments and to rely on the data, which has been scored by the DCF.

Embodiments of the invention allow an organization to avoid or remediate situations with workers in unsatisfactory conditions. This can improve the reputation of the organization. Further, embodiments of the invention allow the remote working conditions to be audited and prove that conditions are acknowledged and that steps are taken to improve the conditions.

In one example, a DCF is a system or collection of hardware (computers, servers, routers, network interface cards, storage including immutable storage and/or other hardware) that is provisioned (e.g., with software, services) to score or rank data that may be ingested into the DCF. The DCF is configured to route the data such that the data ingested into the DCF can be made available to applications, which applications may also be part of the DCF. As the data is routed or pathed, confidence or trust scores are added to the data by the various nodes involved in the flow of the data in the DCF. The routed data is ultimately associated with a confidence score that can be leveraged by applications that use the data.

As data is routed in the DCF, the nodes may perform trust insertion or execute trust insertion technologies. Trust insertion includes, by way of example and not limitation, contributing a confidence or trust score to the data (e.g., by annotating a package including the data with a score or other information about the added score), performing a trust insertion technology on the data (e.g., authentication, data provenance, signatures, secure enclave computing, etc.), or the like or combination thereof.

More specifically, a data confidence fabric, by way of example only, may relate to an architecture and set of services that allow data to be ingested into a system for use by applications. The DCF adds trust or confidence scores to the data as the data flows through the DCF. Combining all of the confidence scores added by the nodes or the trust insertion technologies allows the ingested data to have an overall confidence or trust score that provides a view into the trustworthiness of the data to an application or for other use.

The data scored or ranked in the DCF may be stored in various locations, such as a data lake, in a datacenter, a distributed ledger, a cloud data storage service, or the like or combination thereof. The data scored or ranked in the DCF system can be made available to one or more applications or other clients or users.

Confidence scores allow an application to explore or exploit the data for potential analysis or consumption. The score or rank of the data allows an application to understand or account for the trustworthiness of the data. For example, the confidence score of the data may have a significant impact on whether the data is actually used by the application. An application may require a minimum confidence score or have other requirements related to the confidence score.

A DCF is able to give or associate data with scores from individual trust insertion technologies that can be combined in multiple ways to determine a final score or rank that relates to the trustworthiness of the data. The scores provided from a hardware perspective can be maintained separately from confidence scores from a software perspective. The scores can also be combined into an overall score.

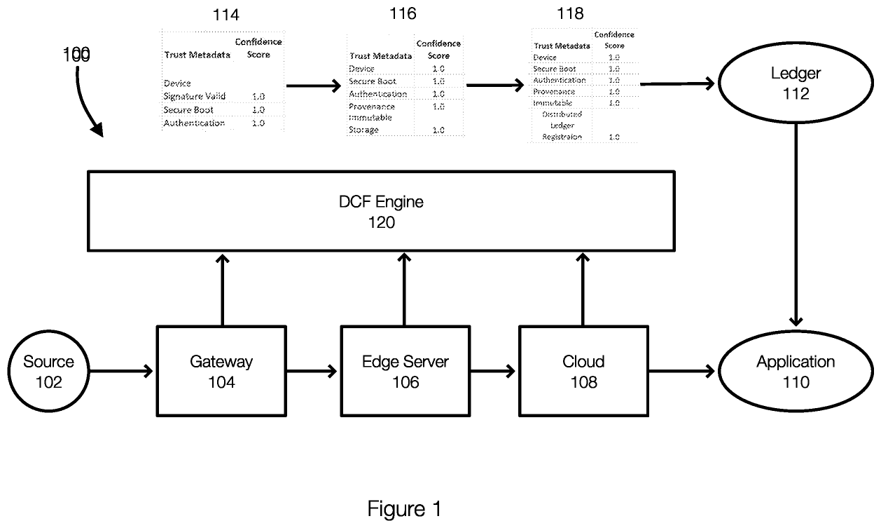

FIG. 1 illustrates an example of a data confidence fabric (DCF 100). The DCF 100 includes varies computing and hardware components, connections, and environments. The DCF 100 is configured to add confidence scores to data flowing in the DCF 100. The DCF 100 may include or be associated with trust insertion technologies such as, but not limited to, ledgers, immutable storage, semantic validation, authentication, data provenance, TPM (Trusted Platform Modules), signatures, or the like or combination thereof.

In this example, a source 102 may generate data that is provided to or ingested into the DCF 100. In this example, the source 102 may represent a source of environment data that is relevant to assessing or monitoring a remote working environment. The source 102 may include sensors (e.g., air quality sensors, temperature sensors, pollutant sensors), websites, databases, wearable devices (e.g., smart watches), computing devices, cameras, microphones, furniture, or the like or combination thereof.

Data generated by or collected from the source 102 may be ingested via a gateway 104. A gateway 104 may be a device capable of connecting with the source 102 and may be connected to a network such as the Internet. The data may then be routed to an edge server 106 and then to the cloud 108, where the data may be stored and made available to an application 110.

As the data is routed or ingested into the DCF, the various components may add trust scores. The trust scores may be added or generated as metadata using a DCF engine 120. The DCF engine 120 may be distributed within the DCF 100 and operate on different devices or servers. Further, some of the trust insertion technologies may be specific to a device. The DCF engine 120 may provide application programming interfaces such that trust scores can be added to data in transit, such that data and/or metadata can be committed to a ledger, perform routing in the DCF 100, and the like or combination thereof.

In the DCF 100, data (or a data stream) arriving at the gateway 104 or transmitted from the gateway is associated with metadata 114, which includes trust scores for a secure boot, authentication, and device signature validation. More specifically, the gateway 104 may annotate three operations in this example as illustrated by the annotations or metadata 114. The gateway 104 may successfully validate the signature coming from the source 102. The gateway 104 may annotate that a TPM chip was used by the source 102 to confirm that the BIOS, firmware, or OS on the source 102 (or on the gateway 104) was not tampered with during boot. The gateway 104 may run authentication/authorization software to protect the data stream from unwanted inspection. The method of scoring may vary. In one example, success may receive a 1.0 and failure may receive a 0.0 for any given trust insertion technology. The overall score or rank may be generated in different manners including addition, weighted addition, multiplication, weighted multiplication, or the like or combination thereof.

At the edge server, additional scores for provenance and immutable storage have been added as illustrated by the metadata 116. The metadata 118 may represent that the data has been stored in immutable storage and is registered in a ledger 112.

The ledger 112 may store the metadata associated with the data generated by the source 102. Use of the data by the application 110 may also be reflected in the ledger 112. The data is thus associated with a confidence score that is based, at least in part, on the trust insertion technologies applied as the data was ingested. The application 110 can then trust the data based on the confidence score. In addition, the ledger 112 allows for auditing operations. In the context of monitoring a remote environment, this may allow conditions to be tracked and audited over time, demonstrate efforts to improve the remote environment, monitor employee compliance with best practices, and the like.

The DCF 100 can thus capture data created within devices or access data from websites or databases and give a confidence score to the data. This allows information or data regarding a remote work environment to be captured or collected and allows the data to be associated with the remote work environments. This will allow third parties to make judgments about the conditions that a worker (or device) is currently experiencing. Further, by associating the data captured from the end device with the physical environment or assets in the physical environment, remote workforce and device conditions can be measured or assessed and data suppliers can also be scored.

Embodiments of the invention allow environment experts to assess data collected and ingested into a DCF (or other system) for various reasons or standards such as health standards, best practice standards, air quality standards, or the like. Embodiments of the invention allow organizations to avoid or improve unsatisfactory working standards, perform audits regarding remote working environments, prove that the organization is actively engaged in providing safe or satisfactory working environments, or the like.

By way of example, the score may further include metadata reflecting that an asset is associated with a sensor that collects air quality data. The metadata may reflect that an asset is associated with a sensor or source that collects physiological data. In some examples, the confidence score may be based on a detailed analysis or based on groupings on different sensor variables. For example, the analysis may performed such that the metadata reflects additional characteristics of the environment such as inhalable particles under 150 μg/m³ based on a 24-hour average, Internet connection above 100 MBS on a 24-hour average, satisfactory physiological measurements based on a personal average, and the like.

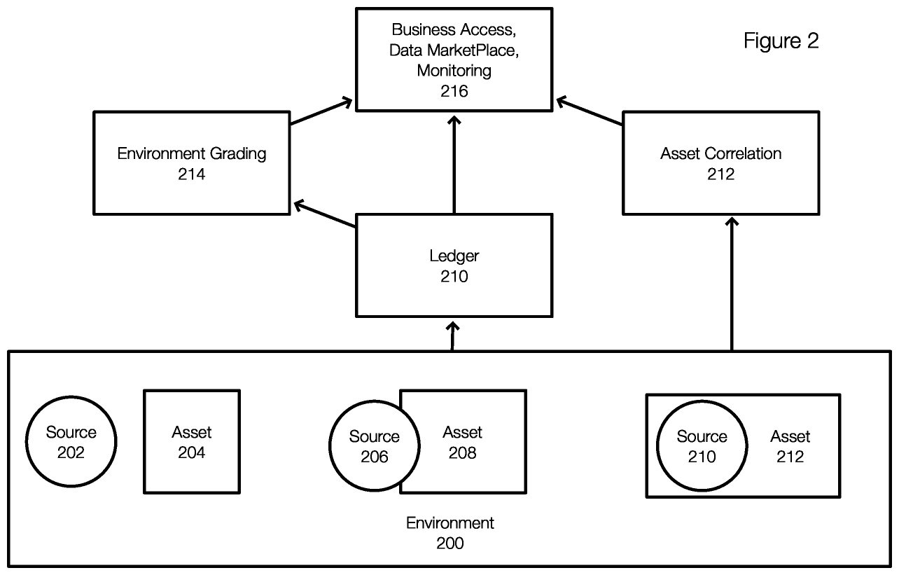

FIG. 2 discloses aspects of monitoring an environment using a DCF. FIG. 2 illustrates an environment 200 that may be associated with at least one asset such as asset 204. The environment 200 may be associated with multiple assets, represented by assets 204, 208, and 212.

In this example, the asset 204 is associated with a source 202. This association between the asset 204 and the source 202 may be automated, manual, predictive, or the like. The source 206 is associated with the asset 208 by being attached to or logically attached to the asset 208. For example, some sensors may attach to the asset 208 via a wireless connection or a wired connection. The source 210 is built-into or part of the asset 212. The sources 202, 206, and 210, which are examples of the source 102, can be software sources or hardware sources.

The assets 204, 208, and 212 may be devices, users, locations, rooms, buildings, or other environments. As illustrated in FIG. 2, embodiments of the invention allow sources to be correlated with assets. Thus, asset correlation 212 may include storage for storing or for correlating data from the sources 202, 206, and 210, which are ingested into a DCF, with the corresponding assets 204, 208, and 212. Correlating the data in asset correlation 212 may allow rules to be implemented. When a rule is broken, for example, a trigger may be performed.

The data received from the sources 202, 206, and 210, once ingested into the DCF, can be analyzed by third parties or applications to rate and/or rank the conditions in which the asset-related data was generated. The ratings and rankings can be automated, manual, predictive, or the like or combination thereof. The ratings and/or rankings may then inform, increase or decrease rank, trust, or other understanding of the data associated with the sources (e.g., the sensors).

The data generated by or collected from the sources 202, 204, and 210 may be categorized into different types including, but not limited to, physical environment data, support environment data, and external environment data. The physical environment data may represent physical aspects of the location of the remote environment 200 (or asset). These physical environment sources may include sensors or other sources that generate data measuring, by way of example only, connectivity, air quality, noise levels, temperature, humidity, heart rate, posture, down time, and the like. In addition to sensors that may, for example, be in the vicinity of the environment 200, data such as air quality may be obtained from other companies that may offer ambient environment measurements (e.g., Google Earth Outreach). This may allow information to be collected to determine whether internal readings of the environment 200 are in line with readings that are external to the environment 200. Different sources or sensors may measure the same or similar aspect or characteristic of or related to the environment 200. This may allow for more objective measurements and allow the measurements to be performed or determined with regard to local standards.

The support environment data may relate to various regulations (e.g., Occupational Safety and Health Administration or OSHA). The support environment data may relate to information describing whether a worker has the tools and processes to perform their job. This may be measured using software that monitors performance or through other mechanisms that match expected hardware and software access against detected capabilities of the asset.

The support environment data may include objective data and subjective data. Objective data may include things that can be objectively measured. For example, whether a worker has a laptop or computer suitable for their job requirements or has sufficient connectivity can be determined. The qualities or capabilities of the worker's equipment and connectivity can be objectively measured via software.

The support environment data may also be subjective. Subjective support environment data may relate to how a worker or employee feels about their job or environment. By way of example, subjective support environment data may be collected via surveys. Subjective support environment data may also be collected from sources such as employer evaluation websites (e.g., glassdoor.com), which are not employer owned or controlled, where employees may be able to express themselves more freely than in an employer provided survey. Information determined from subjective support environment data may help an employer understand how their employees feel and give insight to employee satisfaction or other characteristics. For example, this may allow a user's satisfaction with their working environment to be evaluated. Information from employer evaluation websites may be categorized, analyzed, ranked, or the like.

The external environment data may include objective measurements or data. The external environment data may relate to more than the specific or immediate environment 200 of the worker and may encompass the neighborhood surrounding the environment 200. Air quality, noise quality, open spaces, infrastructure, and the like can be objectively measured. This category of data can place the personal environment 200 of the worker in perspective of the larger environment or neighborhood. This category of data may also be used to deploy resources for the improvement of working conditions based on detected or measured conditions.

The external environment data may also be subjective. Time-boxed events (e.g., protests, weather, earthquake) and longer events (pandemic, power outage, government problems) can impact a remote working environment and the external environment data can be used in different ways. Data from the sensors can be collected periodically, repeatedly, on demand, contractually, or the like. This data can be evaluated, ranked, processed, analyzed and the like. Rules may be applied to the data.

Data generated by or collected from the sources 202, 206, and 210 (which can be hardware sources and/or software sources and may include sensors of various types) are ingested into a DCF and metadata (confidence scores, trust technology, routing) of the data and/or the collected data itself is stored in a ledger 210.

The confidence score associated with data can be generated as the data is ingested into the DCF. Thus, the confidence scores other metadata and/or the data may be stored in a ledger 210. The data may be stored elsewhere in the cloud, such as in immutable storage while the metadata is stored in the ledger.

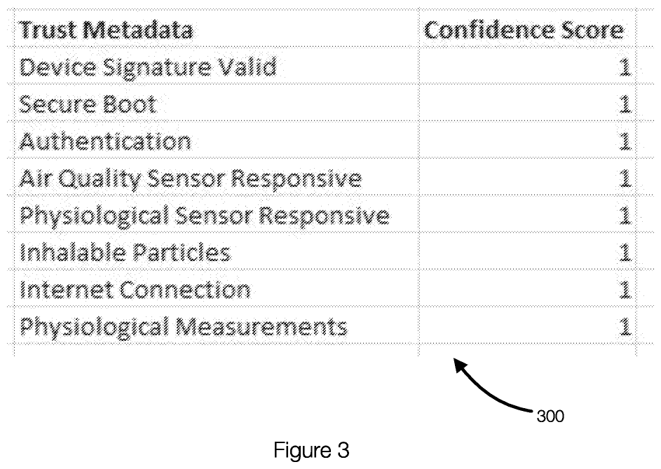

For example, a scoring paradigm may account for the presence of sensor or source data. FIG. 3 illustrates an example of metadata that may be associated with data from a source or sensor. The metadata 300, in this example, scores a 1 for success and a 0 for failure. Thus, the gateway determined that the device signature of the asset was valid, that the asset used a TPM chip to confirm a secure boot, that the asset is running authentication software to protect the data stream, that the asset is associated with an active sensor that collects air quality data and that the asset is associated with an active sensor that collects physiological data.

Using further analysis (e.g., third party or application analysis), the metadata can be augmented to reflect more detailed analysis that may be related to additional variables. The variables could be an individual asset, a group of assets or other groupings. Thus, the metadata may reflect, using this type of analysis, whether the environment has inhalable particles below a threshold overtime, an Internet connection providing a certain speed over time, satisfactory physiological measurements based on a personal average, or the like.

The asset correlation 212 allows a trusted pairing to be created and allows communication to be automated. For example, an administrator may associate a source or sensor to an asset in the asset correlation 212. The assets and/or sources send data to specified locations in the DCF and create entries in the ledger 210. When accessed, a score may be returned with the data.

Environment grading 214 may also be performed. Grades can be generated for environments based on the data ingested into the DCF and based on the confidence scores. The gradings may also be returned to the DCF and included in the ledger 210. This data may be used to influence trust or confidence scores.

For example, the sources providing information about the environment can be accessed and graded based on the data and/or the score. This allows various aspects of a working environment to be graded. By way of example only and not limitation, air quality, temperature, humidity, noise, light, device characteristics, connection speeds, software access, user and user related characteristics (temp, posture, work breaks, productivity) can be graded based on the values and based on their confidence scores. These characteristics can be graded individually and/or collectively. This gives insight into the working environment.

For example, the temperature of an environment may be graded on a pass/fail basis. This grade can be applied to a single measurement, or to an average temperature based on multiple samples. Further, the grading may account for other environmental conditions, such as outdoor temperature or the like.

The data can be used, by way of example, for business processes, data marketplaces, and monitoring 216. Business processes may include monitoring the working conditions of their employees or their vendor's employees such that conditions can be improved where needed, work can be redirected or reassigned based on current conditions, and the like. When substandard conditions are detected, actions may be triggered such as an inquiry to the employee, testing the sources, or the like.

A marketplace may allow data to be bought or sold. More specifically, a particular organization may sell a device (e.g., computers) to many organizations. Because computers have embedded sensors and can communicate with other sources, the organization is positioned to collect data from multiple sources in multiple environments. This allows the organization to provide a monitoring service to the entity that uses or purchases the organization's products.

More specifically, data collected by sources or assets in a DCF can be used to generate a certified fair trade data marketplace. For example, a computer manufacturer can use the sensors in their devices to collect environment information. These devices may also interface with other sensors (e.g., room sensors, worn sensors). This data can be collected and monitored. This service allows employers to ensure that all workers associated with the generated data are working in conditions that meet a standard set by an organization.

Employers can request that employees comply with remote workplace best practices and allow remote sources, such as cameras, to measure their compliance. This allows an employer to ensure that its employees take breaks, stretch, stand, or the like. The employee's posture and other characteristics can be measured. High confidence scores indicate that an employee is complying with best practices. These scores can be used to reward employees or to encourage best practices and also allow a company to respond to workplace violations and/or quickly detect workplace violations. The ledger can indicate the conditions of the remote environment over time and allow for auditing. An organization's reputation for providing good working environments and for responding to problems can be enhanced and verified.

In another example, the data ingested into the DCF can be used to create correlations between working conditions and output. This may allow resources to be directed or redirected as needed to improve conditions in working environments and thus improve output in terms of quantity and/or quality.

In another example, rules may be generated or formed that, when satisfied trigger events or notifications. Using the asset correlation 212, for example, rules may be set or formed such that a notification is generated when air quality is below a threshold for some period of time or when noise level exceeds a threshold for some period of time. The rules may be based on discrete data (e.g., a one-time event), based on time series data, based on averaged or time-series data, or the like.

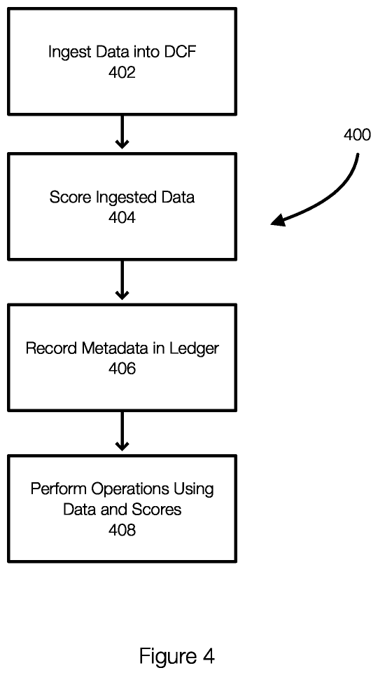

FIG. 4 illustrates an example of a method for environment assessment. The method 400 represents a process from the ingestion of data to the use of data. However, embodiments of the invention may focus on specific aspects of the method. For example, embodiments of the invention may relate to operations including, but not limited to, assessing a remote environment, monitoring a remote environment, grading data generated in or relevant to remote environments, applying rules to scored data, scoring environmental data, marketing data related to remote environments, and the like or combination thereof. Some of the methods may relate to operations that use data ingested into and scored by a DCF.

In the method 400, data is ingested 402 into a DCF. This may include receiving or collected data from sources. In the context of a remote working environment, the sources may include sensors related to the environment such as air quality sensors, temperature sensors, humidity sensors, noise sensors, cameras, microphones, or the like. Software sensors may measure connectivity, device capability, software availability, or the like. As previously stated, the data from the sources may be physical environment data, supporting environment data, and/or external environment data. These types of data, by way of example only, can all be ingested 402 into a DCF.

The data ingested into the DCF is scored 404. In other words, a trust or confidence score may be attached to the data and the data is ingested. This is often reflected in data annotations or metadata that is stored or recorded 406 in a ledger.

Next, operations are performed 408 using the data and the scores 408. The operations performed may be application dependent. In one example, the ingested data may be graded by a grading application. Grading the data may include grading the data individually (per source), grading the data collectively (e.g., per environment, per group of sources or group of similar sources), or the like. Data can be graded, by way of example, as pass/fail. If measured inhalants in ppm is below a threshold, for example, this aspect of the environment may pass. An environment may be suitable when a percentage of the individual characteristics are suitable.

The operations may include a rules application. The rules application may be operate to generate an alert or other action when a rule is satisfied. For example, if two sources measure below corresponding threshold values, an action may be triggered. The action may depend on the specific condition. Certain characteristics (e.g., carbon monoxide above threshold), may trigger a more urgent action than other characteristics (e.g., temperature above normal).

The operations may include allocating resources. In this example, multiple remote environments may be monitored. If one remote environment experiences an event, such as an earthquake, work may be moved to another environment. In addition, resources associated with improving working environments can be directed based on detected conditions.

In another example, the operations performed may include marketplace operations. This allows an entity to sell or provide remote working condition assessments or events to an organization. These assessments may be based on data collected from devices manufactured or sold by the entity. For example, multiple different organizations may use computing devices from an entity. The entity may operate a marketplace by collecting remote environment data via these computing devices. This allows the entity to assess the environments related to each independent organization, allows best practices to be developed based on how each organization interacts with their own remote working environments.

The operations may include monitoring remote working environments for compliance with associated standards. Deviations from a standard can be flagged, for example.

The process of ingesting data may be performed repeatedly, continually, on command, or the like. Data may be ingested as data streams, discrete samples, or the like. This data and the metadata can be stored, and this allows a history to be generated. This facilitates audits, best practice analysis, and the like.

When a DCF captures ambient environment data and generates annotations and scores for that data, the corresponding environments or assets can also be scored. This allows data acquisition decisions to include worker conditions, which benefits the worker and validates that an entity is encouraging and/or providing high quality working conditions.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, environment related operations. Such operations may include, but are not limited to, monitoring operations, assessment operations, rules-based operations, grading operations, compliance operations, and the like. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example. Containers may also be employed.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing. Data may also include sensor data, website or database information, or the like.

Any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

Following are some further example embodiments of the invention. These are presented only by way of example and are not intended to limit the scope of the invention in any way.

Embodiment 1. A method, comprising: A method, comprising: accessing data that has been ingested into a data confidence fabric, wherein the data is collected from or generated by at least one source associated with a working environment, accessing confidence scores associated with the data, and performing an operation related to the working environment based on the data and the confidence scores.

Embodiment 2. The method of embodiment 1, further comprising ingesting the data into the data confidence fabric from the sources, wherein the sources include one or more of hardware sensors, software sensors, websites, databases, or combination thereof.

Embodiment 3. The method of embodiment 1 and/or 2, wherein the data is one or more of physical environment data, subjective supporting environment data, objective supporting environment data, subjective external environment data, or objective external environment data.

Embodiment 4. The method of embodiment 1, 2, and/or 3, further comprising monitoring the data to determine whether the working environment complies with a standard.

Embodiment 5. The method of embodiment 1, 2, 3, and/or 4, further comprising determining that at least one characteristic of the working environment does not comply with the standard and triggering an event based on a rule.

Embodiment 6. The method of embodiment 1, 2, 3, 4, and/or 5, further comprising correlating the data with assets in the working environment.

Embodiment 7. The method of embodiment 1, 2, 3, 4, 5, and/or 6, further comprising grading the data based on the confidence scores.

Embodiment 8. The method of embodiment 1, 2, 3, 4, 5, 6, and/or 7, further comprising annotating the data with confidence scores as the data traverses the data confidence fabric, the confidence scores associated with one or more trust insertion technologies.

Embodiment 9. The method of embodiment 1, 2, 3, 4, 5, 6, 7, and/or 8, further comprising creating a marketplace for multiple organizations based on the data, wherein the data is collected from multiple working environments associated with different entities.

Embodiment 10. The method of embodiment 1, 2, 3, 4, 5, 6, 7, 8, and/or 9, further comprising determining whether employees comply with best practices based on the data and the confidence scores.

Embodiment 11. A method for performing any of the operations, methods, or processes, or any portion of any of these or any combination thereof, disclosed herein.

Embodiment 13. A non-transitory storage medium having stored therein instructions that are executable by one or more hardware processors to perform operations comprising the operations of any one or more of embodiments 1 through 12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

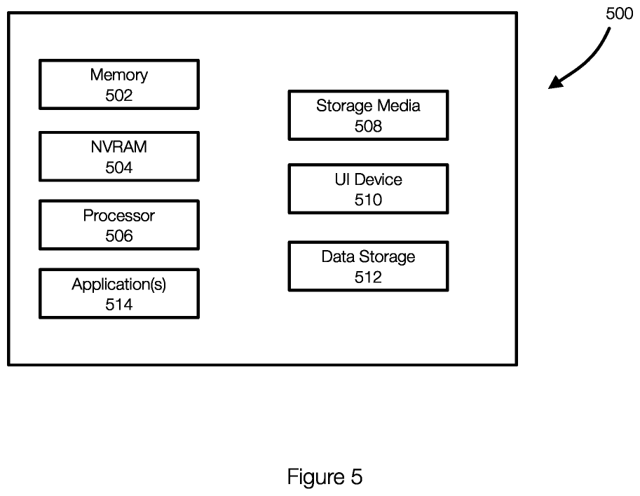

With reference briefly now to FIG. 5, any one or more of the entities disclosed, or implied, by FIGS. 1-5 and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, comprising:
ingesting, into a data confidence fabric, data related to an asset in a working environment associated with a worker of an entity from at least one source associated with the asset, wherein the data includes objective data related to an ability of the worker to perform a job and characteristics of the working environment and subjective data related to how the worker feels about their job and the working environment;
generating confidence scores for the data and associating the confidences scores to the data that has been ingested into the data confidence fabric;
retrieving confidence scores associated with the data; and
performing an operation related to the working environment based on the data and the confidence scores, the operation including determining whether the working environment complies with a standard, wherein deviations from the standard are flagged; and
remedying the deviations.

2. The method of claim 1, wherein the sources include one or more of hardware sensors, software sensors, websites, databases, or combination thereof.

3. The method of claim 1, wherein the objective data includes one or more of physical environment data, objective supporting environment data and objective external environment data and the subjective data includes subjective supporting environment data, or subjective external environment data.

4. (canceled)

5. The method of claim 4, further comprising flagging a deviation by determining that at least one characteristic of the working environment does not comply with the standard and triggering an event based on a rule.

6. The method of claim 1, further comprising correlating the data with assets in the working environment.

7. The method of claim 1, further comprising grading the data based on the confidence scores.

8. The method of claim 1, further comprising annotating the data with confidence scores as the data traverses the data confidence fabric, the confidence scores associated with one or more trust insertion technologies.

9. The method of claim 1, further comprising creating a marketplace for multiple organizations based on the data, wherein the data is collected from multiple working environments associated with different entities.

10. The method of claim 1, further comprising determining whether employees comply with specified practices based on the data and the confidence scores.

11. A non-transitory storage medium having stored therein instructions that are executable by one or more hardware processors to perform operations comprising:
ingesting, into a data confidence fabric, data related to an asset in a working environment associated with a worker of an entity from at least one source associated with the asset, wherein the data includes objective data related to an ability of the worker to perform a job and characteristics of the working environment and subjective data related to how the worker feels about their job and the working environment;
generating confidence scores for the data and associating the confidences scores to the data that has been ingested into the data confidence fabric;
retrieving confidence scores associated with the data; and
performing an operation related to the working environment based on the data and the confidence scores, the operation including determining whether the working environment complies with a standard, wherein deviations from the standard are flagged; and
remedying the deviations.

12. The non-transitory storage medium of claim 11, wherein the sources include one or more of hardware sensors, software sensors, websites, databases, or combination thereof.

13. The non-transitory storage medium of claim 11, wherein the objective data includes one or more of physical environment data, objective supporting environment data and objective external environment data and the subjective data includes subjective supporting environment data, or subjective external environment data.

14. (canceled)

15. The non-transitory storage medium of claim 14, further comprising flagging a deviation by determining that at least one characteristic of the working environment does not comply with the standard and triggering an event based on a rule.

16. The non-transitory storage medium of claim 11, further comprising correlating the data with assets in the working environment.

17. The non-transitory storage medium of claim 11, further comprising grading the data based on the confidence scores.

18. The non-transitory storage medium of claim 11, further comprising annotating the data with confidence scores as the data traverses the data confidence fabric, the confidence scores associated with one or more trust insertion technologies.

19. The non-transitory storage medium of claim 11, further comprising creating a marketplace for multiple organizations based on the data, wherein the data is collected from multiple working environments associated with different entities.

20. The non-transitory storage medium of claim 11, further comprising determining whether employees comply with specified practices based on the data and the confidence scores.
